(19) United States
(12) Patent Application Publication
(10) Pub. No.: US 2009/0014221 A1
(43) Pub. Date: Jan. 15, 2009

(54) LAYOUT STRUCTURE OF LPG BOMB AND INTEGRATED BATTERY OF HYBRID ELECTRIC VEHICLE

(76) Inventors: Hyun Il Kim, Gunpo-si (KR); Seng Jong Lyoo, Ansan-si (KR)

Correspondence Address: MORGAN, LEWIS & BOCKIUS LLP (SF), One Market, Spear Street Tower, Suite 2800, San Francisco, CA, 94105, US

(21) Appl. No.: 11/937,374

(22) Filed: Nov. 8, 2007

(30) Foreign Application Priority Data
Jul. 13, 2007 (KR) 10-2007-0070349

(51) Int. Cl. B60K 1/00

(52) U.S. Cl. 180/65.1; 903/903

(57) ABSTRACT

A layout structure of an LPG bomb and an integrated battery of a hybrid electric vehicle (HEV) is disclosed. An LPG bomb is mounted under a floor and/or rear seat, and an integrated battery module is mounted in a trunk room or behind a rear seat back. To this end, a layout structure of an LPG bomb and an integrated battery of a hybrid electric vehicle includes a plurality of bombs arranged in parallel with each other over two columns and three columns in a space under a vehicle floor and/or rear seats, wherein each bomb is arranged in a horizontal direction or a lengthwise direction with respect to a longitudinal direction of a vehicle.

### CROSS-REFERENCE TO RELATED APPLICATION

This application claims the benefit under 35 U.S.C. §119(a) on Korean Patent Application No. 10-2007-0070349 filed on Jul. 13, 2007, the entire contents of which are incorporated herein by reference.

### BACKGROUND OF THE INVENTION

1. Field of the Invention

The present invention relates a layout structure of an LPG bomb and an integrated battery of a hybrid electric vehicle (HEV), and more particularly, to a layout structure of an LPG bomb and an integrated battery of a hybrid electric vehicle (HEV) in which an LPG bomb is mounted under a floor and/or rear seat and an integrated battery is mounted on a trunk room or behind a rear seat back.

2. Description of the Related Art

Generally, a vehicle which uses liquefied petroleum gas (LPG) as a fuel evaporates an LPG fuel through a mixer and a vaporizer before being supplied into an engine.

However, in such a conventional LGP engine system, the startability of the engine is reduced in the winter, and the power performance and fuel consumption ratio of the engine are decreased. Further, due to a driver's neglect to remove the tar which is created when an LPG fuel is burned, by not observing a scheduled maintenance, a lot of problems occurs such as unstable idling and engine stalling.

To solve the above-mentioned problems, a liquefied petroleum injection (LPI) engine system has been suggested.

The LPI engine system is configured such that a fuel pump is installed in a bomb to supply LPG fuel of a liquefied state through a fuel supplying line, and the LPG fuel is injected by an injector in an engine, unlike a typical LPG engine which injects an LPG fuel by a vapor pressure of a fuel.

In this LPI engine system, since an engine control unit (ECU) precisely controls the injector so that an LPG fuel can be directly injected to a combustion chamber by an injector without using a mixer and a vaporizer, the fuel consumption ratio, the power performance and the startability of the engine are improved, and thus vehicle maintenance to address the buildup of tar is not required.

In a fuel supplying system of such an LPI engine system, a fuel pump for pumping a LPG fuel of a liquefied state is mounted in a bomb in which an LPG fuel is stored and then the LPG fuel is pumped from the fuel pump to a fuel supplying line through a multi valve. The pumped LPG fuel is injected into a combustion chamber by an injector, and a remaining fuel is returned to a bomb through a fuel returning line.

Meanwhile, in an LPI engine vehicle, two or three LPG bombes are mounted according to the kind of a vehicle in case of a multi-purpose vehicle (MPV) such as a recreational vehicle (RV) and a sport utility vehicle (SUV).

Korean Patent Publication No. 2006-57685 discloses a layout structure of a bomb of an LPI engine vehicle in which a bomb for storing an LPG fuel is located between left and right rear seats.

Japanese Patent Publication No. 2000-219050 discloses a structure of a vehicle in which a small-diameter cylinder and a large-diameter cylinder for accommodating compressed natural gas (CNG) are installed below a vehicle seat.

Typically, in the conventional hybrid electric vehicle, an integrated battery is located in a trunk room, and an LPG bomb is mounted in a trunk room. Because of this structure, the trunk room of conventional hybrid electric vehicle does not accommodate many articles or things in the trunk room. Therefore the LPG bomb which can be efficiently arranged without or with little changing a location of the existing integrated battery module and the layout of the vehicle which is more compact are required.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the aforementioned problems associated with prior arts.

In one aspect, the present invention provides a layout structure of an LPG bomb and an integrated battery of a hybrid electric vehicle (HEV) in which an integrated battery module is mounted in a trunk room or behind a rear seat back and an LPG bomb is mounted under a floor and/or rear seat of the vehicle, so that the LPG bomb is efficiently arranged without or with little changing a location of the existing integrated battery module, leading to a compact vehicle layout.

In a preferred embodiment, the present invention provides a layout structure of an LPG bomb and an integrated battery of a hybrid electric vehicle, comprising: a plurality of LPG bombs arranged in parallel with each other over two columns or three columns in a space under the floor and/or rear seats of vehicle, wherein each LPG bomb is arranged in a horizontal direction or a lengthwise direction with respect to a longitudinal direction of the vehicle.

In a further preferred embodiment, an integrated battery module is arranged behind a rear seat back or in a trunk room. The integrated battery module is configured to include integrally in a single case a battery and battery-related parts such as a low DC-DC converter and a battery management system.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic view illustrating a state that a battery is mounted in a conventional LPG hybrid electric vehicle which uses an LPG fuel;

FIG. 2 is a schematic view illustrating a layout structure of an LPG bomb (horizontal direction) and integrated battery of a hybrid electric vehicle according to an exemplary embodiment of the present invention; and

FIG. 3 is a schematic view illustrating a layout structure of an LPG bomb (lengthwise direction) and integrated battery of a hybrid electric vehicle according to another exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

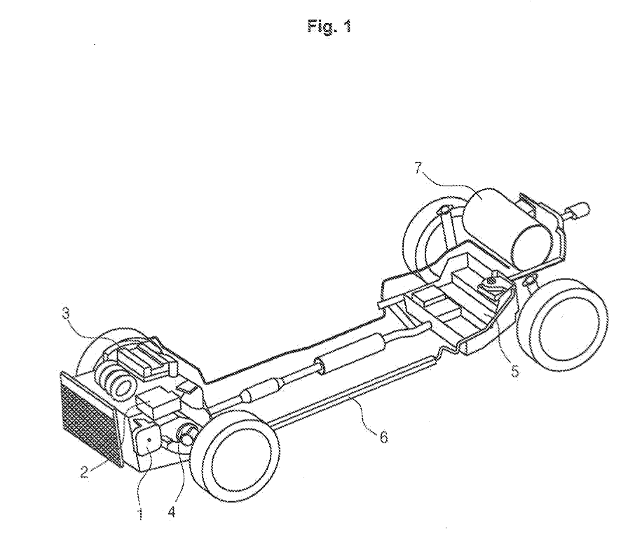

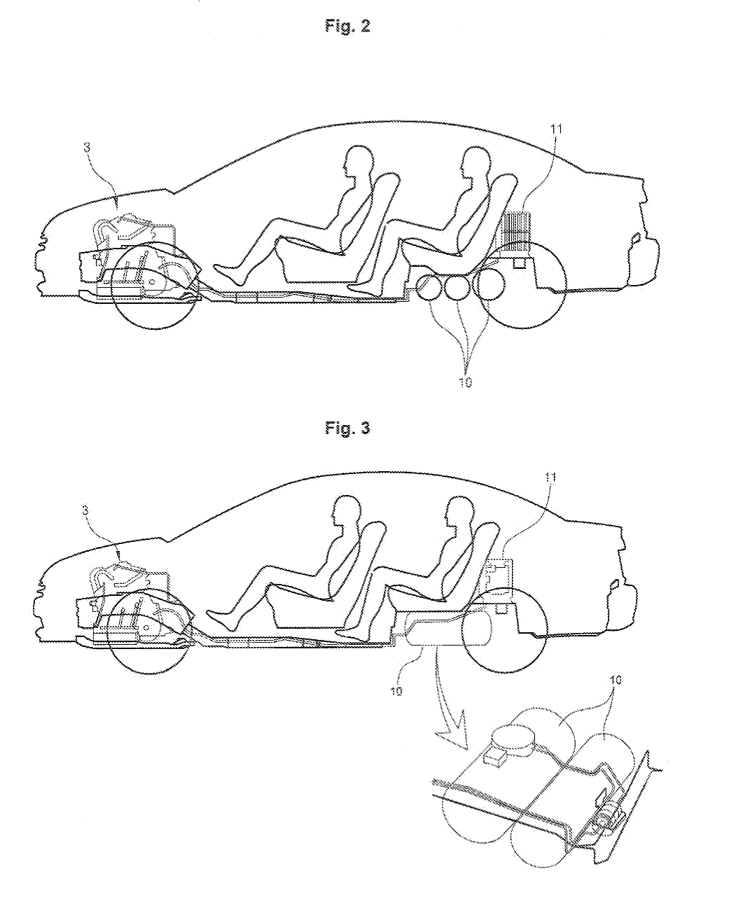

FIG. 1 is a schematic view illustrating a state that a battery is mounted in a conventional LPG hybrid electric vehicle which uses an LPG fuel. FIG. 2 is a schematic view illustrating a layout structure of an LPG bomb (horizontal direction) and integrated battery of a hybrid electric vehicle according to an exemplary embodiment of the present invention. FIG. 3 is a schematic view illustrating a layout structure of an LPG bomb (lengthwise direction) and integrated battery of a hybrid electric vehicle according to another exemplary embodiment of the present invention.

Generally, a hybrid electric vehicle is a vehicle which efficiently combines two types of power sources to drive itself. i.e., the typical hybrid electric vehicle obtains driving force from an engine 3 using a fuel and an electric motor 1 driven by electrical power of a battery 5. The hybrid electric vehicle can have various structures with the engine 3 and the electric motor 1 as a power source, and most hybrid electric vehicles employ either a parallel or serial type of structure.

In the parallel type of structure, the engine 3 charges the battery 5 but is designed to directly drive a vehicle together with the electric motor 1. However, the parallel type structure has disadvantages in that a structure and control logic are relatively complicated, whereas mechanical energy of the engine 3 and electrical energy of the battery 5 can be used together efficiently. For these advantages, the parallel type structure is widely employed in a car.

Particularly, since an optimal operating region of the engine 3 and the electric motor 1 is used, the fuel consumption ratio of the whole driving system is improved, and because when a driver brakes mechanical energy is retrieved to the battery 5, it is possible to efficiently use energy.

Such a hybrid electric vehicle necessarily has the high voltage battery 5 for providing driving force to the electric motor, and the high voltage battery 5 supplies power to the electric motor through repetitive charging/discharging operations while driving.

In the typical hybrid electric vehicle, the electric motor 1 and an inverter 2 are mounted in an engine room together with the engine 3 and a transmission 4, and the high voltage battery 5 is mounted below a rear seat as shown in FIG. 1. The high voltage battery 5 mounted below the rear seat is electrically connected to electrical parts of the engine room through a power cable 6.

Recently, in the hybrid electric vehicle, the high voltage battery 5 is mounted in a form integrated with battery-related parts such as the inverter and a low DC-DC converter. In case of the LPG hybrid electric vehicle, the integrated battery assembly is mounted below the rear seat, that is, below an under floor and above a rear cross member, in order to avoid interference with a fuel tank (i.e., LPG bomb 7) installed in the trunk room.

In contrast, according to one exemplary embodiment of the present invention, in case of the hybrid electric vehicle having two, three or more seat columns, a plurality of LPG bomb 10 are mounted in a space over two, three or more seat columns below the floor and/or below the rear seat, and each LPG bomb 10 is arranged in a horizontal direction which is perpendicular to a longitudinal direction of a vehicle body as shown in FIG. 2 or in a lengthwise direction which is a longitudinal direction of the vehicle body as shown in FIG. 3.

In a preferred embodiment, the front and rear LPG bombs arranged in parallel to the central LPG bombs are connected in fluid communication through a fuel tube (not shown) of a lower end portion.

In case of the hybrid electric vehicle having the LPI engine, a fuel pump for pumping an LPG fuel of a liquefied state is mounted in the LPG bomb 10 storing an LPG fuel and the LPG fuel pumped by the fuel pump is injected into a combustion chamber of the engine 3 through the injector.

In a preferred embodiment of the present invention, the integrated battery module 11 of the hybrid electric vehicle wherein a battery and battery-related parts are integrally installed in a single case is arranged behind a rear seat back or in a trunk room.

The integrated battery module 11 is configured such that a high voltage battery, an inverter, a low DC-DC converter, a battery management system, and battery-related electrical devices are integrally installed in a single case.

As described above, in an embodiment, the integrated battery module may be mounted in the trunk room or behind a rear seat back, and the LPG bomb may be mounted under the floor and/or rear seat of the vehicle.

Therefore, the LPG bomb is efficiently arranged without or with little changing a location of the existing integrated battery module installed in the trunk room and thus the layout of the vehicle can be more compact.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A layout structure of an LPG bomb and an integrated battery of a hybrid electric vehicle, comprising:
at least a bomb arranged in parallel with each other over at least a column in a space under a floor and/or rear seat of the vehicle, wherein each bomb is arranged in a horizontal direction or a lengthwise direction with respect to a longitudinal direction of the vehicle.

2. The layout structure of claim 1, wherein the integrated battery module is arranged behind a rear seat back or in a trunk room.

3. The layout structure of claim 1 or 2, wherein the integrated battery module is configured to include integrally in a single case a battery and battery-related parts such as an inverter, a low DC-DC converter and a battery management system.
